(19) United States
(12) Patent Application Publication
(10) Pub. No.: US 2026/0176500 A1
(43) Pub. Date: Jun. 25, 2026

(54) ADHESIVE TAPES FOR WIRE HARNESS APPLICATION

(71) Applicant: Scapa Italia SpA, Ghislarengo (VC) (IT)

(72) Inventors: Angelo Leone, Ghislarengo (VC) (IT); Corrado Basile, Ghislarengo (VC) (IT)

(21) Appl. No.: 19/426,573

(22) Filed: Dec. 19, 2025

(30) Foreign Application Priority Data
Dec. 20, 2024 (IT) 102024000029475

(51) Int. Cl. C09J 7/29; C09J 133/08

(52) U.S. Cl. CPC C09J 7/29; C09J 133/08; C09J 2203/354; C09J 2423/04; C09J 2433/00

(57) ABSTRACT

An adhesive tape suitable for use within an automotive engine comprises a first layer with a halogen-free composition having a melting point equal to or greater than 100° C. and equal to or less than 160° C., a second layer of polyethylene, a third layer with a second halogen-free composition having a melting point equal to or greater than 100° C. and equal to or less than 160° C., and a fourth layer of adhesive. The first and second halogen-free compositions may include polypropylene. The polyethylene may be selected from low density polyethylene, linear low density polyethylene, high density polyethylene, or combinations thereof. The adhesive may be an acrylic adhesive. The tape exhibits specific thicknesses for each layer and elongation at break values in both machine and cross directions. At least one surface of the tape undergoes corona surface treatment. The tape may include a primer layer between the third and fourth layers and can be wound about a cylindrical support. The method of forming the tape involves coextruding the first, second, and third layers and applying the adhesive layer.

### CROSS-REFERENCE TO RELATED APPLICATIONS

This application claims the benefit of Italian Application Serial No. 102024000029475, filed Dec. 20, 2024, the complete disclosure of which is incorporated herein by reference.

### TECHNICAL FIELD

This disclosure pertains to the field of adhesive tapes for high temperature applications in automotive, electrical, and electronics industries.

### BACKGROUND

Various industrial applications require materials that provide bonding. These materials often need specific characteristics such as heat resistance, flexibility, and strong adhesion to meet the demands of different environments. The protection of cables and wires, for example, is traditionally implemented using adhesive tapes made from plasticized polyvinyl chloride (PVC) due to its heat resistance and flexibility. Such properties are of importance in applications such as automotive wire harnessing. However, such plasticizers have been found to migrate into the adhesive layer reducing adhesion. Additionally, PVC by its nature contains halogens (chlorine) which can release toxic vapors during incineration, making PVC difficult to recycle. The need for alternatives that align with safety and environmental regulations has become increasingly important.

Existing solutions may also face challenges in maintaining performance under high temperatures or in providing adequate adhesion to diverse surfaces. The development of materials that can withstand such conditions while remaining flexible and environmentally friendly is a significant focus for manufacturers. The integration of components that offer thermal stability, flexibility, and strong adhesive properties without harmful substances represents an advancement in this field.

Previous attempts to replace PVC tape backing have utilized polypropylene (PP) for its high heat resistance. However, PP lacks the necessary elasticity to be employed as an adhesive tape backing alone. Polyethylene (PE) performs well in low temperatures, however, exhibits poor thermal properties in applications that require long term heat resistance.

Multi-layer tapes incorporating PP and heat resistance-modified PE have been developed, however, suffer from chemical incompatibility which requires process additives to produce. Such additives migrate into the adhesive, reducing the adhesive adhesion.

Therefore, there exists a need for a multi-layer halogen free adhesive tape which maintains flexibility, exhibits high heat resistance over time, and is readily recyclable.

### SUMMARY

Accordingly, this description presents an adhesive tape and manufacturing method thereof that addressed the aforementioned challenges by utilizing a multi-layer adhesive backing and adhesive disposed thereon. By including a first halogen-free layer having high heat resistance, a second layer having high flexibility, and a third halogen-free layer having high heat resistance, the adhesive tape provides a sustainable alternative to non-recyclable PVC adhesives while preventing adhesion-reducing migration.

### BRIEF DESCRIPTION OF THE DRAWINGS

FIG. 1A is a schematic of an example adhesive tape for use in automotive engines;

FIG. 1B is a schematic of an example adhesive tape for use in automotive engines;

FIG. 2A is a block diagram of an example method of manufacturing an example adhesive tape for use in automotive engines; and

FIG. 2B is a block diagram of an example method of manufacturing an example adhesive tape for use in automotive engines.

### DESCRIPTION OF EMBODIMENTS

This description and the accompanying drawings describe different embodiments encompassed by the claims for illustration purposes and should not be taken as limiting, with the claims defining the scope of the present invention. Various mechanical, compositional, structural, and operational changes may be made without departing from the scope of this description and the claims. In some instances, structures and techniques well-known in the field have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

When a layer is being described as “on” or “over” another layer, it is to be understood that the layers can either be directly contacting each other or have another intervening layer therebetween, unless expressly stated to the contrary. The terms are thus simply describing the relative position of the layers to each other and do not necessarily mean “on top of” since the relative position above or below depends on the orientation of the viewer.

As used herein, “first”, “second”, and “third” may be used interchangeably to distinguish one component from another and are not intended to signify location or important of the individual components.

Except as otherwise noted, the dimensions and values disclosed herein are not to be understood as being strictly limited to the exact numerical values recited. Instead, unless otherwise specified, such value is intended to mean both the recited value and a functionally equivalent range surrounding that value. For instance, whether the word “about” or “approximately” are present or not, the values as presented may be rounded up to the next lower or higher decimal value. For example, 40.15 mm is intended to mean strictly 40.15 mm or “about 40.15 mm”, meaning that the value may vary from 40.10 mm to 40.20 mm. Similarly, 0.122 is intended to mean strictly 0.122 mm or “about 0.122 mm”, which may comprise from 0.120 mm to 0.130 mm. The materials, methods, and examples described herein are illustrative.

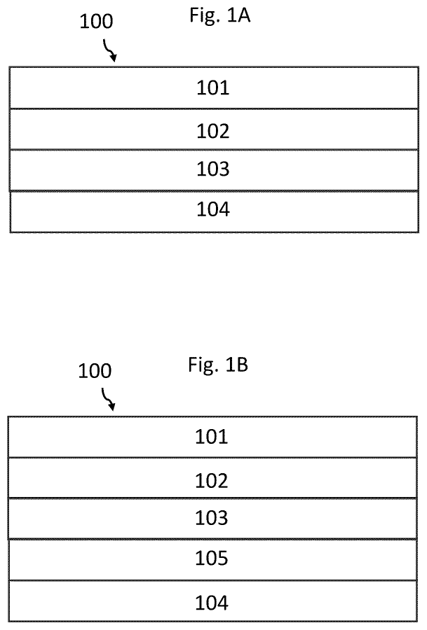

The adhesive tape 100 suitable for use in an automotive engine comprises at least four layers. The adhesive tape 100 includes the following layers in the following order: a first layer 101 comprising a first halogen-free composition having a melting point equal to or greater than 100° C. and equal to or less than 160° C., preferably equal to or greater than 110° C. and equal to or less than 160° C., more preferably equal to or greater than 130° C. and equal to or less than 160° C.; a second layer 102 comprising polyethylene; a third layer 103 comprising a second halogen-free composition having a melting point equal to or greater than 100° C. and equal to or less than 160° C., preferably equal to or greater than 110° C. and equal to or less than 160° C., more preferably equal to or greater than 130° C. and equal to or less than 160° C.; and a fourth layer 104 comprising adhesive (see FIG. 1A). In some embodiments, the second layer 102 directly contacts one or more of the first layer 101 and the third layer 103. In other embodiments, at least one additional layer may be disposed between the first layer 101 and the second layer 102, between the second layer 102 and the third layer 103, or both.

The multi-layer construction of the adhesive tape 100, comprising the first layer 101, the second layer 102, the third layer 103, and the fourth layer 104 provides a balance of high heat resistance and flexibility. This arrangement allows the tape to withstand the high temperatures typically found in automotive applications while maintaining the necessary flexibility for wrapping around wire harnesses.

A halogen-free composition refers to a material formulation that does not contain halogen elements such as fluorine, chlorine, bromine, iodine, or astatine. These compositions are designed to reduce the release of toxic halogenated compounds during manufacturing, use, or disposal, making them more environmentally friendly and safer for applications where heat resistance and recyclability are of relevance, such as in adhesive tapes for wire harness applications.

By utilizing halogen-free compositions in the first layer 101 and third layer 103, the adhesive tape 100 addresses environmental and safety concerns associated with traditional PVC tapes, which release toxic halogens during incineration. This makes the tape more environmentally friendly and suitable for applications where recyclability is important.

The inclusion of the second layer 102 comprising polyethylene between the first layer 101 and the third layer 103 enhances the tape's flexibility, allowing it to conform to various shapes and surfaces without compromising its thermal stability. This is particularly advantageous in automotive applications where the adhesive tape 100 must adapt to complex wire configurations.

Furthermore, by utilizing the compositions for each of the first layer 101, second layer 102, and third layer 103, the adhesive tape 100 maintains chemical compatibility which does not require additional process additives to be co-extruded together and maintain a strong adhesion between each of the first layer 101, second layer 102, and third layer 103 to any adjacent layers thereof.

The fourth layer 104 ensures strong adhesion to the underlying layers and the surfaces it is applied to, providing reliable performance in high-temperature environments. This combination of layers results in an adhesive tape 100 that not only meets the thermal and mechanical demands of automotive wire harness applications but also aligns with modern environmental standards.

According to some embodiments, the first and second halogen-free compositions may comprise polypropylene. Polypropylene is a thermoplastic polymer made from the polymerization of propylene monomers. It is known for its high heat resistance, chemical resistance, and mechanical strength, making it suitable for various applications, including automotive and industrial uses. In the context of adhesive tapes, polypropylene provides a halogen-free alternative with good thermal stability and recyclability. The polypropylene for use in the first halogen-free composition may be any of a polypropylene homopolymer, random copolymer, block copolymer, or impact copolymer so long as the melting point is within the aforementioned melting temperature range for each of the first layer 101 and third layer 103. This melting point is of consequence in order to ensure long-lasting heat resistance in automotive applications wherein such tapes are subjected to extended periods of high heat. However, if the melting point of the halogen-free composition is above 160° C., it may lead to increased manufacturing costs and process complexities given the high heat necessary to manipulate the composition into forming the adhesive tape 100.

By utilizing polypropylene in both the first and second halogen-free compositions, the adhesive tape 100 achieves enhanced thermal stability and mechanical strength. This choice of material ensures that the adhesive tape 100 can withstand high temperatures typically encountered in automotive applications, while maintaining its structural integrity. The use of polypropylene also contributes to the recyclability of the adhesive tape 100, aligning with environmental standards and reducing the release of toxic substances during disposal.

The consistent use of polypropylene in both halogen-free layers simplifies the manufacturing process by reducing the need for multiple material sources and compatibility checks. This uniformity in material selection minimizes the risk of chemical incompatibility, which can lead to adhesion-reducing migration of additives into the adhesive layer 100, thereby maintaining strong adhesion over time.

In some embodiments, one or more of the first and second halogen-free compositions may further comprise additional halogen-free components such as polyethylene. In such embodiments, one or more of the first and second halogen-free compositions may include a weight ratio of polypropylene to polyethylene of 50:50 to 90:10, preferably 60:40 to 80:20. In a most preferred embodiment, one or more of the first and second halogen-free compositions includes 70 wt % very low density polyethylene (VLLDPE) and 30 wt % polypropylene copolymer. Use of such a blend ensures sufficient mechanical strength and heat resistance for use in high temperature environments such as in automotive engines.

In some embodiments, the first and second halogen-free compositions are the same. By ensuring that the first and second halogen-free compositions are the same, the adhesive tape 100 achieves uniformity in material properties across the layers, which simplifies the manufacturing process. This uniformity reduces the risk of chemical incompatibility between layers, thereby preventing the migration of additives into the adhesive layer 100 that could weaken adhesion over time. The consistent use of the same material in both halogen-free compositions enhances the thermal stability and mechanical strength of the adhesive tape 100, making it more reliable for high-temperature applications such as automotive engines.

In other embodiments, the first and second halogen-free compositions may be different compositions. By allowing the first and second halogen-free compositions to be different, the adhesive tape 100 can be tailored to meet specific performance requirements. This flexibility in material selection enables the control of thermal stability and mechanical properties for various applications. For instance, one layer can be tailored for higher heat resistance while the other can be tailored for enhanced mechanical strength, providing a customized solution for different automotive environments.

In some embodiments, the polyethylene composition comprising the second layer 102 may be selected from the group consisting of low density polyethylene (LDPE), linear low density polyethylene (LLDPE), high density polyethylene (HDPE), and combinations thereof.

Low density polyethylene (LDPE) refers to a polyethylene material produced typically by high-pressure free-radical polymerization, characterized by a significant degree of long-chain branching. LDPE exhibits a lower density generally in the range of about 0.910-0.935 g/cm³, a lower crystallinity relative to other polyethylene grades, and correspondingly higher flexibility, toughness, and ease of conformability.

Linear low density polyethylene (LLDPE) refers to a polyethylene material produced predominantly by low-pressure coordination polymerization, wherein ethylene is copolymerized with one or more alpha-olefins (e.g., butene, hexene, octene) to introduce controlled short-chain branching while maintaining a substantially linear backbone. LLDPE exhibits a density typically in the range of about 0.915-0.940 g/cm³, with higher tensile strength and puncture resistance than LDPE at comparable densities, improved toughness, and good film properties.

High density polyethylene (HDPE) refers to a polyethylene material produced by low-pressure coordination polymerization, characterized by minimal branching and a highly linear molecular structure leading to high crystallinity. HDPE exhibits a higher density typically in the range of about 0.940-0.970 g/cm³, increased stiffness, tensile strength, and chemical resistance relative to LDPE and LLDPE.

By selecting polyethylene from the group consisting of LDPE, LLDPE, and HDPE, the adhesive tape 100 achieves a balance of flexibility and thermal stability. This selection allows the adhesive tape 100 to conform to various shapes and surfaces, which is particularly advantageous in automotive applications where the tape must adapt to complex wire configurations.

In a preferred embodiment, the second layer 102 is formed of LDPE. Incorporating LDPE in the second layer 102 of the adhesive tape 100 enhances flexibility while maintaining the necessary thermal properties for automotive applications. LDPE's lower density allows the adhesive tape 100 to conform more easily to complex wire configurations, providing a snug fit without compromising the tape's structural integrity. This flexibility is crucial for applications where the adhesive tape 100 must adapt to various shapes and surfaces, such as in wire harnesses within automotive engine cavities.

The fourth layer 104 comprising the adhesive may comprise an acrylic adhesive. An acrylic adhesive is a type of adhesive made from acrylic polymers, known for its strong bonding properties, durability, and resistance to environmental factors such as temperature and UV light. It is often used in applications requiring high temperature resistance and flexibility, making it suitable for automotive, electrical, and electronics industries. Acrylic adhesives can be water-based or solvent-based, with water-based versions being more environmentally friendly. Example acrylic adhesives include aqueous dispersions of acrylate copolymers containing ethoxylated alkyl phenol or any other acrylic adhesive compositions known in the art.

Incorporating an acrylic adhesive in the fourth layer 104 enhances the tape's bonding properties, providing strong adhesion to various surfaces, which is crucial for maintaining the integrity of wire harnesses in high-temperature environments. Acrylic adhesives are known for their durability and resistance to environmental factors such as temperature and UV light, making them suitable for automotive applications where the adhesive tape 100 must endure harsh conditions without losing adhesion.

The use of an acrylic adhesive also aligns with environmental considerations, as water-based acrylic adhesives are more environmentally friendly compared to solvent-based alternatives. This choice supports the overall goal of creating a sustainable and recyclable adhesive tape 100, reducing the release of harmful substances during manufacturing and disposal.

In some embodiments, a thickness of the first layer 101 may be equal to or greater than 10 microns and equal to or less than 60 microns, preferably equal to or greater than 20 microns and equal to or less than 50 microns, more preferably equal to or greater than 30 microns and equal to or less than 40 microns. All thickness measurements are determined according to AFERA 5006.

By specifying that the thickness of the first layer 101 is equal to or greater than 10 microns and equal to or less than 60 microns, preferably equal to or greater than 20 microns and equal to or less than 50 microns, more preferably equal to or greater than 30 microns and equal to or less than 40 microns, the adhesive tape 100 achieves a controlled balance between durability and flexibility. This precise thickness range ensures that the first layer 101 provides sufficient heat resistance without becoming too rigid, which is crucial for maintaining the tape's performance in high-temperature automotive environments.

The defined thickness range of the first layer 101 also contributes to the overall structural integrity of the adhesive tape 100, ensuring that it can withstand mechanical stresses and maintain strong adhesion over time. This is particularly important in automotive applications where the adhesive tape 100 is subjected to continuous vibrations and temperature fluctuations.

Additionally, the specified thickness range allows for efficient manufacturing processes, as it provides a clear guideline for producing the first layer 101 with consistent quality. This consistency in production helps in maintaining the reliability and performance of the adhesive tape 100 across different batches, ensuring that it meets the stringent requirements of automotive wire harness applications.

In some embodiments, a thickness of the second layer 102 may be equal to or greater than 1 micron and equal to or less than 30 microns, preferably equal to or greater than 5 microns and equal to or less than 20 microns, more preferably equal to or greater than 10 microns and equal to or less than 15 microns. By specifying that the thickness of the second layer 102 is equal to or greater than 1 micron and equal to or less than 30 microns, preferably equal to or greater than 5 microns and equal to or less than 20 microns, more preferably equal to or greater than 10 microns and equal to or less than 15 microns, the adhesive tape 100 achieves a controlled balance between flexibility and structural integrity. This precise thickness range ensures that the second layer 102 provides sufficient flexibility to conform to various shapes and surfaces, which is crucial for applications such as automotive wire harnesses where the adhesive tape 100 must adapt to complex configurations.

The defined thickness range of the second layer 102 also contributes to the overall durability of the tape, ensuring that it can withstand mechanical stresses and maintain strong adhesion over time. This is particularly important in high-temperature environments where the adhesive tape 100 is subjected to continuous vibrations and temperature fluctuations, such as within an automotive engine cavity.

Additionally, the specified thickness range allows for efficient manufacturing processes, as it provides a clear guideline for producing the second layer 102 with consistent quality. This consistency in production helps in maintaining the reliability and performance of the adhesive tape 100 across different batches, ensuring that it meets the stringent requirements of automotive wire harness applications.

In some embodiments, a thickness of the third layer 103 may be equal to or greater than 10 microns and equal to or less than 60 microns, preferably equal to or greater than 20 microns and equal to or less than 50 microns, more preferably equal to or greater than 30 microns and equal to or less than 40 microns. By specifying that the thickness of the third layer 103 is equal to or greater than 10 microns and equal to or less than 60 microns, preferably equal to or greater than 20 microns and equal to or less than 50 microns, more preferably equal to or greater than 30 microns and equal to or less than 40 microns, the adhesive tape 100 achieves a controlled balance between durability and flexibility. This precise thickness range ensures that the third layer 103 provides sufficient heat resistance without becoming too rigid, which is crucial for maintaining the tape's performance in high-temperature automotive environments.

The defined thickness range of the third layer 103 also contributes to the overall structural integrity of the adhesive tape 100, ensuring that it can withstand mechanical stresses and maintain strong adhesion over time. This is particularly important in automotive applications where the adhesive tape 100 is subjected to continuous vibrations and temperature fluctuations.

Additionally, the specified thickness range allows for efficient manufacturing processes, as it provides a clear guideline for producing the third layer 103 with consistent quality. This consistency in production helps in maintaining the reliability and performance of the adhesive tape 100 across different batches, ensuring that it meets the stringent requirements of automotive wire harness applications.

In some embodiments, the thickness of the first layer 101 and third layer 103 may be the same. By ensuring that the first layer 101 and third layer 103 have the same thickness, the adhesive tape 100 achieves uniformity in its structural properties, which simplifies the manufacturing process and ensures consistent performance across the adhesive tape 100. This uniformity helps in maintaining the balance between heat resistance and flexibility, which is crucial for high-temperature applications such as automotive wire harnesses.

The consistent thickness of the first layer 101 and third layer 103 also contributes to the overall durability and reliability of the adhesive tape 100, as it ensures that first layer 101 and third layer 103 provide equal levels of thermal stability and mechanical strength. This is particularly important in environments where the adhesive tape 100 is subjected to continuous vibrations and temperature fluctuations, as it helps in maintaining strong adhesion and preventing delamination over time.

Additionally, having the same thickness for the first layer 101 and third layer 103 allows for more efficient use of materials and reduces the complexity of the manufacturing process. This can lead to cost savings and improved production efficiency, while still meeting the stringent requirements of automotive applications.

In other embodiments, the thickness of the first layer 101 and third layer 103 may be different. By allowing the first layer 101 and third layer 103 to have different thicknesses, the adhesive tape 100 can be tailored to meet specific performance requirements for various applications. This flexibility in design enables the control of thermal stability and mechanical properties, ensuring that the adhesive tape 100 can withstand high temperatures and mechanical stresses encountered in automotive environments. For instance, a thicker first layer 101 can provide enhanced heat resistance, while a thinner third layer 103 can offer improved flexibility, resulting in a customized solution that balances durability and adaptability.

This variation in thickness also allows for more efficient use of materials, potentially reducing manufacturing costs and improving production efficiency. By controlling the thickness of each layer according to the specific demands of the application, the adhesive tape 100 can achieve superior performance without unnecessary material waste, aligning with both economic and environmental considerations.

In some embodiments, the adhesive tape 100 exhibits an elongation at break in the machine direction of equal to or greater than 100% and equal to or less than 350%, preferably equal to or greater than 150% and equal to or less than 300%, more preferably approximately 200%. The elongation is determined according to AFERA 5004 A.

By specifying that the adhesive tape 100 exhibits an elongation at break in the machine direction of equal to or greater than 100% and equal to or less than 350%, preferably equal to or greater than 150% and equal to or less than 300%, more preferably approximately 200%, the adhesive tape 100 achieves a high degree of flexibility and durability. This ensures that the adhesive tape 100 can stretch and conform to various shapes and surfaces without breaking, which is particularly important in automotive applications where the adhesive tape 100 must adapt to complex wire configurations and withstand continuous vibrations and temperature fluctuations.

The defined elongation at break values contribute to the overall mechanical performance of the adhesive tape 100, ensuring that it maintains strong adhesion and structural integrity over time. This is crucial for maintaining the reliability and effectiveness of wire harnesses in high-temperature environments, such as within an automotive engine cavity.

Additionally, the specified elongation at break values allow for efficient manufacturing processes, as they provide clear guidelines for producing the adhesive tape 100 with consistent quality. This consistency in production helps in maintaining the reliability and performance of the adhesive tape 100 across different batches, ensuring that it meets the stringent requirements of automotive wire harness applications.

In some embodiments, the adhesive tape 100 exhibits a tensile strength in the machine direction of equal to or greater than 10 N/mm² and equal to or less than 40 N/mm², preferably equal to or greater than 15 N/mm² and equal to or less than 35 N/mm², more preferably equal to or greater than 20 N/mm² and equal to or less than 30 N/mm²; and a tensile strength in the cross direction of equal to or greater than 15 N/mm² and equal to or less than 30 N/mm², preferably equal to or greater than 20 N/mm² and equal to or less than 27 N/mm², more preferably equal to or greater than 22 N/mm² and equal to or less than 25 N/mm². The tensile strength is determined according to AFERA 5004.

By specifying that the adhesive tape 100 exhibits a tensile strength in the machine direction of equal to or greater than 10 N/mm² and equal to or less than 40 N/mm², preferably equal to or greater than 15 N/mm² and equal to or less than 35 N/mm², more preferably equal to or greater than 20 N/mm² and equal to or less than 30 N/mm², and a tensile strength in the cross direction of equal to or greater than 15 N/mm² and equal to or less than 30 N/mm², preferably equal to or greater than 20 N/mm² and equal to or less than 27 N/mm², more preferably equal to or greater than 22 N/mm² and equal to or less than 25 N/mm², the adhesive tape 100 ensures high mechanical performance and durability. This tensile strength range provides the necessary robustness to withstand mechanical stresses and strains encountered in automotive applications, particularly within engine cavities where the adhesive tape 100 is subjected to continuous vibrations and temperature fluctuations.

The defined tensile strength values contribute to the overall structural integrity of the adhesive tape 100, ensuring that it maintains strong adhesion and does not tear or break under high-stress conditions. This is crucial for maintaining the reliability and effectiveness of wire harnesses in high-temperature environments, ensuring that the wires remain securely bundled and protected.

Additionally, the specified tensile strength values allow for efficient manufacturing processes, as they provide clear guidelines for producing the adhesive tape 100 with consistent quality. This consistency in production helps in maintaining the reliability and performance of the adhesive tape 100 across different batches, ensuring that it meets the stringent requirements of automotive wire harness applications.

At least one surface of the adhesive tape 100 is subjected to a corona surface treatment. Preferably both a surface of the third layer 103 between the third layer 103 and the fourth layer 104 and an exterior surface of the first layer 101 are subjected to a corona surface treatment.

Corona surface treatment is a process used to increase the surface energy of a material, typically a polymer, to improve its adhesion properties. This is achieved by exposing the material to a corona discharge, which is a high-frequency electrical discharge that ionizes the air around the material, creating reactive species that modify the surface. This treatment enhances the material's ability to bond with adhesives, inks, or coatings.

Subjecting at least one surface of the tape to a corona surface treatment enhances the adhesion properties of the adhesive tape 100. The corona treatment creates reactive sites on the surface, which facilitates stronger adhesion between the adhesive tape 100 and the surfaces it is applied to, ensuring reliable performance in high-temperature environments such as automotive engine cavities. This treatment is particularly beneficial in applications wherein the adhesive tape 100 must maintain strong adhesion despite exposure to heat and mechanical stress. By improving the bonding capability, the corona-treated surface helps prevent delamination and ensures the adhesive tape 100 remains securely attached to wire harnesses, contributing to the overall durability and effectiveness of the adhesive tape 100 in demanding conditions.

In particular, by subjecting a surface of the third layer 103 between the third layer 103 and the fourth layer 104 to a corona surface treatment, the wetting properties of the third layer 103 may be improved, resulting in improved adhesion between the third layer 103 and the acrylic adhesive of the fourth layer 104. By subjecting an exterior surface of the first layer 101 to a corona surface treatment, the surface tension of the first layer 101 may be improved. This may improve adhesion between the exterior surface of the first layer 101 and the adhesive in the fourth layer 104 when the adhesive tape 100 is wrapped so as to overlap itself.

The surface of the third layer 103 between the third layer 103 and the fourth layer 104 may be subjected to the corona surface treatment and then the fourth layer 104 may be coated on the third layer 103 as a liquid. The third layer 103 and the fourth layer 104 may then be dried. The exterior surface of the first layer 101 is then subjected to the corona surface treatment. By conducting these process steps in this order, the integrity and placement of the adhesive of the fourth layer 104 is maintained. In the event the adhesive tape 100 is spooled, the adhesive tape 100 exhibits higher affinity between the third layer 103 and the fourth layer 104 than between the fourth layer 104 and an overlapping exterior surface of the first layer 101. This reduces or mitigates the risk of delamination of the fourth layer 104 from the third layer 103 during unspooling.

In some embodiments, the third layer 103 and the first layer 101 are subjected to corona surface treatments of substantially equal magnitude. In other embodiments, the third layer 103 is subjected to a corona surface treatment greater in magnitude than the first layer 101. The magnitude of the corona surface treatment may be determined by the intensity and/or duration of the treatment. By treating the third layer 103 with a corona surface treatment greater in magnitude than the first surface 101, a risk of delamination of the fourth layer 104 from the third layer 103 may be reduced or mitigated.

In some embodiments, the fourth layer 104 directly contacts the third layer 103. In other embodiments, the adhesive tape 100 may further comprise a primer layer 205 between the third 103 layer and the fourth layer 104 (See FIG. 1).

Incorporating a primer layer 105 between the third layer 103 and the fourth layer 104 enhances the adhesion between the adhesive and the underlying layers. The primer layer 105 acts as a bonding agent, improving the overall integrity and durability of the adhesive tape 100. The primer layer 105 ensures that the fourth layer 104 adheres more effectively to the third layer 103, preventing delamination and maintaining strong adhesion over time, even in high-temperature environments such as automotive engine cavities. The use of the primer layer 105 also reduces the magnitude of the corona surface treatment necessary to ensure adhesion between the third layer 103 and fourth layer 104 during spooling and unspooling of the adhesive tape 100 during the shelf life of the adhesive tape 100.

The primer layer 105 also contributes to the tape's performance by providing a stable interface that can accommodate the different material properties of the fourth layer 104 and the third layer 103. This stability is crucial for maintaining the tape's structural integrity under mechanical stresses and temperature fluctuations, ensuring reliable performance in demanding automotive applications.

By including a primer layer 105, the manufacturing process can achieve a more consistent and reliable bond between the fourth layer 104 and the third layer 103, reducing the risk of adhesive failure and enhancing the tape's overall effectiveness in protecting wire harnesses within automotive engines.

The coating weight of the primer layer 105 after drying may be equal to or greater than 0.5 g/m² and equal to or less than 3 g/m², preferably equal to or greater than 1 g/m² and equal to or less than 2 g/m². Coating weight is determined by weighing the adhesive tape 100 before application of the primer layer 105 and after the primer layer 105 is dried and calculating the difference.

Selecting a coating weight of the primer layer within the above range ensures proper film forming of the primer layer and the adhesive layer disposed thereon. Coating weights greater than 3 g/m² may result in uneven or incomplete film formation whereas coating weight less than 0.5 g/m² may result in ineffective adhesion promotion between the third layer 103 and the fourth layer 104 by the primer layer 105.

The adhesive tape 100 may be wound about a core. Winding the adhesive tape 100 about a core provides a convenient and efficient way to store and handle the adhesive tape 100, facilitating its application in automotive environments. This arrangement allows for easy dispensing and reduces the risk of damage or contamination to the layers, ensuring that the adhesive properties are maintained until the adhesive tape 100 is applied. By forming a spool, the adhesive tape 100 can be efficiently transported and stored, minimizing space requirements and protecting the adhesive tape 100 from environmental factors that could degrade its performance. This is particularly advantageous in industrial settings where large quantities of adhesive tape 100 are used, as it streamlines the workflow and reduces waste.

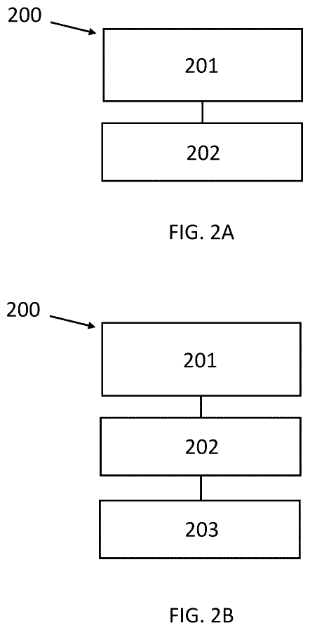

In another aspect, a method 200 for producing the adhesive tape 100 includes a coextruding step 201 of coextruding the first layer 101, second layer 102, and third layer 103, and a coating step 202 of coating the fourth layer 104 (see FIG. 2A).

By coextruding the first layer 101, second layer 102, and third layer 103, the method 200 ensures a strong and uniform bond between the layers, enhancing the overall structural integrity and performance of the adhesive tape 100. This coextrusion process allows for precise control over the thickness and composition of each layer, resulting in an adhesive tape 100 that consistently meets the required specifications for high-temperature automotive applications.

The coextrusion process also simplifies the manufacturing workflow by integrating the formation of multiple layers into a single step, reducing production time and costs. This efficiency in manufacturing contributes to the consistent quality of the adhesive tape 100 ensuring that each batch exhibits the same high level of heat resistance, flexibility, and adhesion properties necessary for reliable performance in automotive wire harness applications.

Additionally, the coextrusion method minimizes the risk of delamination and chemical incompatibility between layers, as the materials are combined in a controlled environment. This results in a more durable and reliable adhesive tape 100 that can withstand the mechanical stresses and temperature fluctuations encountered in automotive engine cavities, thereby improving the longevity and effectiveness of the wire harness protection.

By providing the adhesive in the coating step 202, the method minimizes the risk of unintentional mixing of components and allows for precise application of adhesive on the desired location. This results in a more reliable process with more consistent production results, reducing manufacturing cost due to error and improving consumer satisfaction.

In some embodiments, the method further comprises a winding step 203 of winding the adhesive tape 100 about a core to form a spool (See FIG. 2A). The winding step 203 ensures the adhesive tape 100 can be efficiently transported and stored, minimizing space requirements and protecting the adhesive tape 100 from environmental factors that could degrade its performance. This is particularly advantageous in industrial settings where large quantities of adhesive tape 100 are used, as it streamlines the workflow and reduces waste.

In another aspect, the adhesive tape 100 may be used such that adhesive tape 100 is applied to harnessing wires within an automotive engine cavity. Applying the adhesive tape 100 to harnessing wires within an automotive engine cavity ensures that the wires are protected from high temperatures and mechanical stresses typically encountered in such environments. The multi-layer construction of the adhesive tape 100 which includes halogen-free compositions and polyethylene, provides a balance of heat resistance and flexibility, making it suitable for the complex configurations of wire harnesses. This application enhances the durability and reliability of the wire harnesses, preventing potential damage and ensuring consistent performance of the automotive electrical system.

Furthermore, the use of halogen-free materials in the adhesive tape 100 reduces the release of toxic substances during incineration, aligning with environmental and safety regulations. This makes the adhesive tape 100 a more sustainable and safer option for automotive applications, contributing to the overall environmental friendliness of the vehicle manufacturing process.

Persons skilled in the art will understand that the products and methods specifically described herein are non-limiting exemplary embodiments. The features illustrated or described in connection with one exemplary embodiment may be combined with the features of other embodiments. Various alternatives and modifications can be devised by those skilled in the art without departing from the disclosure. Accordingly, the disclosure is intended to embrace all such alternatives, modifications and variances. As well, one skilled in the art will appreciate further features and advantages of the disclosure based on the above-described embodiments. Accordingly, the disclosure is not to be limited by what has been particularly shown and described, except as indicated by the appended claims.

Hereby, all issued patents, published patent applications, and non-patent publications that are mentioned in this specification are herein incorporated by reference in their entirety for all purposes, to the same extent as if each individual issued patent, published patent application, or non-patent publication were specifically and individually indicated to be incorporated by reference.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of presently disclosed embodiments. Thus the scope of the embodiments should be determined by the appended claims and their legal equivalents, rather than by the examples given.

Persons skilled in the art will understand that the devices and methods specifically described herein and illustrated in the accompanying drawings are non-limiting exemplary embodiments. The features illustrated or described in connection with one exemplary embodiment may be combined with the features of other embodiments. Various alternatives and modifications can be devised by those skilled in the art without departing from the disclosure. Accordingly, the disclosure is intended to embrace all such alternatives, modifications and variances. As well, one skilled in the art will appreciate further features and advantages of the disclosure based on the above-described embodiments. Accordingly, the disclosure is not to be limited by what has been particularly shown and described, except as indicated by the appended claims.

1. An adhesive tape suitable for use within an automotive engine comprising:
a first layer comprising a first halogen-free composition having a melting point equal to or greater than 100° C. and equal to or less than 160° C.
a second layer comprising polyethylene;
a third layer comprising a second halogen-free composition having a melting point equal to or greater than 100° C. and equal to or less than 160° C.; and
a fourth layer comprising an adhesive.

2. The adhesive tape of claim 1, wherein the melting point of the first layer is equal to or greater than 110° C. and equal to or less than 160° C.

3. The adhesive tape of claim 1, wherein the melting point of the third layer is equal to or greater than 110° C. and equal to or less than 160° C.

4. The adhesive tape of claim 1, wherein the first and second halogen-free compositions comprise polypropylene.

5. The adhesive tape of claim 1, wherein the first and second halogen-free compositions are the same.

6. The adhesive tape of claim 1, wherein the polyethylene is selected from the group consisting of low density polyethylene, linear low density polyethylene, high density polyethylene, and combinations thereof.

7. The adhesive tape of claim 1, wherein the adhesive comprises an acrylic adhesive.

8. The adhesive tape of claim 1, wherein a thickness of the first layer is equal to or greater than 10 microns and equal to or less than 60 microns.

9. The adhesive tape of claim 1, wherein thickness of the second layer (102) is equal to or greater than 1 micron and equal to or less than 30 microns.

10. The adhesive tape of claim 1, wherein a thickness of the third layer (103) is equal to or greater than 10 microns and equal to or less than 60 microns.

11. The adhesive tape of claim 1, wherein the adhesive tape exhibits an elongation at break in the machine direction of equal to or greater than 100% and equal to or less than 350%.

12. The adhesive tape of claim 1, wherein the adhesive tape exhibits a tensile strength in the machine direction of equal to or greater than 10 N/mm² and equal to or less than 40 N/mm².

13. The adhesive tape of claim 1, wherein at least one surface of the adhesive tape has been subjected to a corona surface treatment.

14. The adhesive tape of claim 1, further comprising a primer layer between the third layer and the fourth layer.

15. The adhesive tape of claim 1, wherein the coating weight of the primer layer is equal to or greater than 0.5 g/m² and equal to or less than 3 g/m².

16. The adhesive tape of claim 1, wherein the adhesive tape is wound about a core.

17. A use of the adhesive tape of claim 1 within an automotive engine, wherein the adhesive tape is applied to harnessing wires within an automotive engine cavity.
